(19) United States
(12) Patent Application Publication
(10) Pub. No.: US 2026/0274268 A1
(43) Pub. Date: Sep. 17, 2026

(54) TRAVELING STATE DETERMINATION APPARATUS AND VEHICLE

(71) Applicant: SUBARU CORPORATION, Tokyo (JP)

(72) Inventors: Yasushi TAKASO, Tokyo (JP); Toshiki KANBAYASHI, Tokyo (JP)

(21) Appl. No.: 19/551,064

(22) Filed: Feb. 26, 2026

(30) Foreign Application Priority Data
Mar. 12, 2025 (JP) 2025-038975

(51) Int. Cl. B60W 40/10

(52) U.S. Cl. CPC B60W 40/10; B60W 2520/10; B60W 2552/15; B60W 2552/30; B60W 2552/53

(57) ABSTRACT

A traveling state determination apparatus configured to be applied to a vehicle includes a memory and a control processor. The memory is configured to hold vehicle behavior data acquired by a vehicle sensor configured to detect a behavior of the vehicle. The control processor is configured to determine swaying of the vehicle during traveling, based on the vehicle behavior data held in the memory. The control processor is configured to perform: a first determination process of determining the swaying of the vehicle, based on a change in a distance of the vehicle with respect to a division line provided on a road surface on which the vehicle travels; and a second determination process of determining the swaying of the vehicle, based on the vehicle behavior data, when the division line is not detected.

### CROSS-REFERENCE TO RELATED APPLICATIONS

The present application claims priority from Japanese Patent Application No. 2025-038975 filed on Mar. 12, 2025, the entire contents of which are hereby incorporated by reference.

### BACKGROUND

The disclosure relates to a traveling state determination apparatus and a vehicle including the traveling state determination apparatus.

A known technique detects swaying of a vehicle during traveling. For example, Japanese Unexamined Patent Application Publication (JP-A) No. H09-39601 discloses a drowsy driving warning apparatus that: selectively captures a front or rear road surface image from a camera mounted on a vehicle, as an inspection image, to obtain data on a traveling zone division line based on the inspection image; and calculates a degree of swaying of the vehicle from the obtained data on the traveling zone division line.

### SUMMARY

An aspect of the disclosure provides a traveling state determination apparatus configured to be applied to a vehicle. The traveling state determination apparatus includes a memory and a control processor. The memory is configured to hold vehicle behavior data acquired by a vehicle sensor configured to detect a behavior of the vehicle. The control processor is configured to determine swaying of the vehicle during traveling, based on the vehicle behavior data held in the memory. The control processor is configured to perform: a first determination process of determining the swaying of the vehicle, based on a change in a distance of the vehicle with respect to a division line provided on a road surface on which the vehicle travels; and a second determination process of determining the swaying of the vehicle, based on the vehicle behavior data, when the division line is not detected.

An aspect of the disclosure provides a vehicle including a traveling state determination apparatus and a vehicle sensor. The vehicle sensor is configured to detect a behavior of the vehicle. The traveling state determination apparatus includes a memory and a control processor. The memory is configured to hold vehicle behavior data acquired by the vehicle sensor. The control processor is configured to determine swaying of the vehicle during traveling, based on the vehicle behavior data held in the memory. The control processor is configured to perform: a first determination process of determining the swaying of the vehicle, based on a change in a distance of the vehicle with respect to a division line provided on a road surface on which the vehicle travels; and a second determination process of determining the swaying of the vehicle, based on the vehicle behavior data, when the division line is not detected.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram illustrating a configuration example of a vehicle including a traveling state determination apparatus according to one example embodiment.

FIG. 2 is a schematic diagram illustrating a configuration example of the traveling state determination apparatus and peripheral devices thereof according to one example embodiment.

FIG. 3 is a flowchart illustrating a traveling state determination method according to one example embodiment.

FIG. 4 is a flowchart illustrating a vehicle behavior data acquisition process in the traveling state determining method according to one example embodiment.

FIG. 5 is a flowchart illustrating a traveling state determination method according to one example embodiment.

FIG. 6 is a flowchart illustrating a vehicle behavior data acquisition process in the traveling state determining method according to one example embodiment.

### DETAILED DESCRIPTION

According to JP-A No. H09-39601, a degree of swaying of a vehicle may be calculated based on data on a traveling zone division line in an image acquired by a camera. However, when the data on the traveling zone division line is not recognizable from the road surface image captured by the camera because of, for example, snow or fog, the calculation of the degree of swaying of the vehicle has to be stopped. Because the degree of swaying of the vehicle is thus calculated when the data on the traveling zone division line is acquirable, a further improvement is requested of an assist function during traveling.

It is desirable to provide a traveling state determination apparatus that makes it possible to determine swaying of a vehicle even when a traveling zone division line on a road surface on which the vehicle travels is not recognizable, and a vehicle including the traveling state determination apparatus. The traveling zone division line may hereinafter be simply referred to as a “division line”.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Other configurations than those described in detail below may be complemented as appropriate by elemental techniques and configurations regarding known vehicles, including JP-A No. H09-39601.

### First Example Embodiment

### Vehicle 100

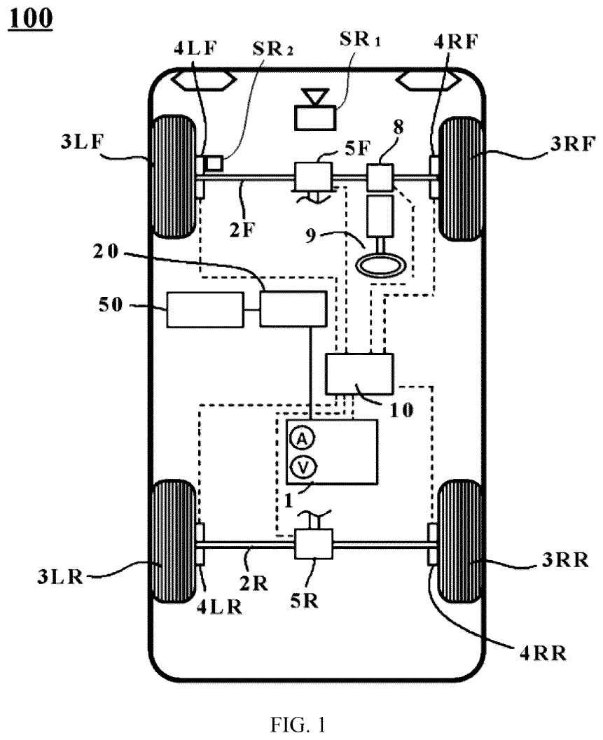

FIG. 1 is a schematic diagram illustrating a configuration example of a vehicle 100 according to a first example embodiment. As the vehicle 100 according to the example embodiment, various known electrically powered vehicles driven by an electric motor and mountable with a battery 1 to be described later may be applied. Non-limiting examples of such electrically powered vehicles may include an electric vehicle, a hybrid electric vehicle (HEV), and a plug-in hybrid electric vehicle (PHEV). As the battery 1 according to the example embodiment, various known secondary batteries such as a lithium-ion secondary battery or a nickel-metal hydride battery may be applied.

Although the electrically powered vehicle described above is exemplified below as an example of the vehicle according to the example embodiment, for example, a known vehicle mounted with a prime mover such as an engine instead of an electric motor may be applied as the vehicle according to the example embodiment. Further, the vehicle according to the example embodiment is not limited to the illustrated four-wheel vehicle and may be a vehicle with another configuration, such as a two-wheel vehicle, as long as sway determination to be described later is applicable.

As illustrated in FIG. 1, the vehicle 100 may be configured to supply electric power from the battery 1 to an electric motor 50 via a known converter 20, under the control of a control processor 10 to be described later. The converter 20 according to the example embodiment may include a known AC/DC converter and a known DC/AC converter that appropriately perform conversion between a DC current and an AC current. The converter 20 may also include, for example, a known DC/DC converter that adjusts a voltage value of a DC current to a desired voltage value.

The vehicle 100 may be configured as, for example, a four-wheel drive vehicle that transmits a driving torque outputted from the electric motor 50 to a left front wheel 3LF, a right front wheel 3RF, a left rear wheel 3LR, and a right rear wheel 3RR (hereinafter, collectively referred to as “drive wheels 3” unless a distinction is to be made between them). The electric motor 50 according to the example embodiment is not particularly limited, and a known electric motor mountable on an electrically powered vehicle may be applied.

The electric motor 50 may output the driving torque to be transmitted to a front-wheel drive shaft 2F and a rear-wheel drive shaft 2R via an unillustrated known transmission, a known front-wheel differential mechanism 5F, and a known rear-wheel differential mechanism 5R. The example embodiment describes an example in which the single electric motor 50 distributes the driving torque to the wheels. In some embodiments, one electric motor 50 may be disposed for each of the front wheel side and the rear wheel side, or one electric motor 50 may be disposed for each of the drive wheels 3.

The electric motor 50 may be electrically coupled to the battery 1 via the above-described converter 20. The control processor 10 may perform control to supply electric power to be used to drive the electric motor 50 from the battery 1 via the converter 20, and to charge the battery 1 with electric power generated by the electric motor 50 by regeneration via the converter 20. As illustrated, the battery 1 according to the example embodiment may include a known voltage sensor configured to detect a voltage value and a known current sensor configured to detect a current value.

The vehicle 100 according to the example embodiment may include, for example, a known electric steering device 8 and known brake devices 4LF, 4RF, 4LR, and 4RR (hereinafter, collectively referred to as “brake devices 4” unless a distinction is to be made between them), as equipment to be used for driving control of the vehicle. In the example embodiment, the front-wheel drive shaft 2F may be provided with the above-described electric steering device 8. The electric steering device 8 may include an unillustrated known motor and unillustrated known gears that drive the electric steering. The electric steering device 8 may adjust steered angles of the left front wheel 3LF and the right front wheel 3RF by being controlled by the control processor 10 that controls the vehicle.

The control processor 10 may be configured as one of one or more known electronic control units (ECUs). The control processor 10 may include one or more processors and one or more memories communicably coupled to the one or more processors. The processor may be, for example, a central processing unit (CPU). In addition, the control processor 10 may be configured to be coupled to a known external network NT such as the Internet via any of various known communication devices CD. The communication device CD may be, for example, communication via a smartphone, or an in-vehicle communicator. The control processor 10 may be electrically coupled, directly or via an in-vehicle communication system such as a controller area network (CAN) or a local interconnect network (LIN), to the known communication device CD, a vehicle sensor SR to be described later, a known memory MD, and a known notification device PD. Non-limiting examples of the memory MD may include a hard disk and a solid state drive (SSD). The notification device PD may include a speaker SP and a display DP.

The vehicle sensor SR according to the example embodiment may include a surrounding environment sensor SR₁ and a vehicle state sensor SR₂.

The surrounding environment sensor SR₁ may include, for example, an illustrated known front imaging camera and an unillustrated known rear imaging camera. The front imaging camera may be configured to capture an image of a region in front of the vehicle 100, and generate image data including a division line on a road surface on which the vehicle 100 is to travel. The rear imaging camera may be configured to capture an image of a region behind the vehicle 100, and similarly generate image data including the division line on the road surface on which the vehicle 100 has traveled.

The front imaging camera and the rear imaging camera may each include, for example, a known image sensor such as a charged coupled device (CCD) or a complementary metal-oxide semiconductor (CMOS). The front imaging camera and the rear imaging camera may each transmit the generated image data to the control processor 10. Although the front imaging camera is illustrated as a monocular camera in the vehicle 100 illustrated in FIG. 1, the front imaging camera may be configured as, for example, a stereo camera including a pair of left and right image sensors. In some embodiments, the surrounding environment sensor SR₁ may include one or more known ranging sensors out of a light detection and ranging (LiDAR), a radar sensor such as a millimeter wave radar, and an ultrasonic sensor.

The vehicle state sensor SR₂ may include at least one sensor that detects a state of the vehicle 100. In one example, the vehicle state sensor SR₂ according to the example embodiment may include a sensor such as a known yaw rate sensor configured to detect a yaw rate of the vehicle 100 or a known vehicle speed sensor configured to detect a vehicle speed of the vehicle 100. The vehicle state sensor SR₂ according to the example embodiment may include a known steering angle sensor configured to detect a steering angle of a steering wheel 9 of the vehicle 100. In addition to the above-described vehicle speed sensor, the vehicle state sensor SR₂ may include, for example, a known acceleration sensor, a known lateral acceleration sensor, or a known angular velocity sensor. A detection signal of the vehicle state sensor SR₂ may be transmitted to the above-described control processor 10.

The vehicle sensor SR may further include an unillustrated global navigation satellite system (GNSS) sensor. The GNSS sensor may be a known sensor that receives satellite signals from positioning satellites such as global positioning system (GPS) satellites. The GNSS sensor may transmit data on a position of the vehicle 100 included in the received satellite signals to the control processor 10. Note that the GNSS sensor may include, in addition to a GPS sensor, an antenna that receives satellite signals from another satellite system configured to identify the position of the vehicle 100.

Described below is a configuration of a traveling state determination apparatus including the control processor 10 configured to determine swaying of the vehicle 100 that is traveling.

### Configuration of Traveling State Determination Apparatus

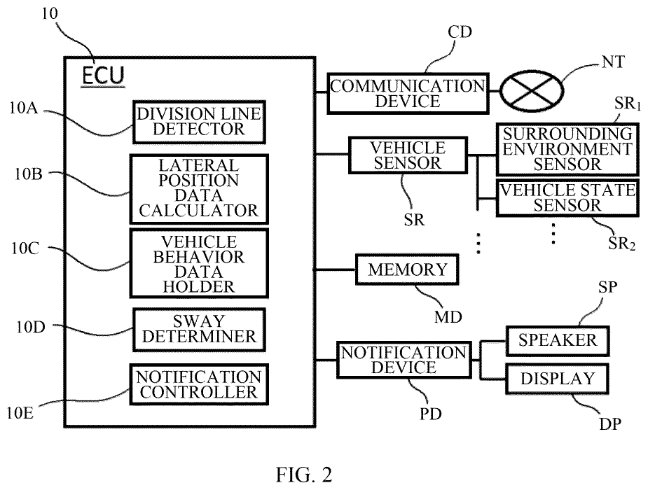

FIG. 2 illustrates a configuration example of the traveling state determination apparatus according to the example embodiment. As illustrated, the traveling state determination apparatus according to the example embodiment includes at least the memory MD that holds vehicle behavior data acquired by the vehicle sensor SR, and the control processor 10 that determines the swaying of the vehicle 100 during traveling based on the vehicle behavior data held in the memory MD. Although the control processor 10 and the memory MD are configured separately in the illustrated example, the memory MD may be included in the control processor 10.

The control processor 10 may include a division line detector 10A, a lateral position data calculator 10B, a vehicle behavior data holder 10C, a sway determiner 10D, and a notification controller 10E.

### Division Line Detector 10A

The division line detector 10A may be configured to, for example, detect the division line provided on the road surface on which the vehicle 100 travels via the above-described surrounding environment sensor SR₁. The division line detector 10A may detect the division line provided on the road surface while the vehicle 100 is traveling by, for example, a known technique exemplified in JP-A No. 2018-063584 or JP-A No. 2023-054084.

### Lateral Position Data Calculator 10B

The lateral position data calculator 10B may be configured to, for example, calculate a distance between the division line detected by the division line detector 10A and the vehicle 100. This distance may also be referred to as lateral position data with respect to the division line. The lateral position data calculator 10B according to the example embodiment may store a temporal change in the above-described lateral position data, i.e., periodicity data of the lateral position. As a method of detecting the above-described lateral position data, a known technique described in, for example, JP-A No. 2002-163642 may be applied.

### Vehicle Behavior Data Holder 10C

The vehicle behavior data holder 10C may be configured to store, as the vehicle behavior data, data related to a vehicle behavior of the vehicle 100 that is traveling in the memory MD. Non-limiting examples of the vehicle behavior data may include data measured by the above-described sensors mounted on the vehicle 100, including the yaw rate measured by the yaw rate sensor, steering angle data of the steering wheel 9 measured by the steering angle sensor, and lateral acceleration rate data measured by the lateral acceleration sensor. The vehicle behavior data holder 10C may store, for example, the vehicle behavior data (e.g., the yaw rate or the steering angle data) of the vehicle 100 when it is determined that “a sway warning is to be issued” by the sway determiner 10D.

### Sway Determiner 10D

The sway determiner 10D may be configured to determine the swaying on the road surface on which the vehicle 100 travels. In one example, the sway determiner 10D may perform FFT calculation on a history of the position of the vehicle (a vehicle position) from the division line detected by the division line detector 10A, i.e., the temporal change in the lateral position data, to calculate magnitudes of respective frequency components.

Here, when a driver who drives the vehicle feels drowsy to drive due to fatigue, for example, the swaying of the vehicle can occur. It has been found that, during such swaying, a component with a low frequency and a large amplitude (e.g., 0.08 Hz to 0.1 Hz) increases in the temporal change in the lateral position data. This component may also be referred to as a “specific frequency component”. Note that such a specific frequency component may also be preset by, for example, experiment or simulation.

### Normal Sway Determination Process

In view of the above, the sway determiner 10D according to the example embodiment may calculate a ratio of the above-described specific frequency component, from among the frequency components in a frequency spectrum obtained by the FFT calculation on the history of the vehicle position from the division line. The sway determiner 10D may determine the calculated ratio as a degree of swaying of the vehicle, and compare the ratio with a predetermined threshold. The history of the vehicle position from the division line may be, for example, the temporal change in the lateral position data through traveling by a predetermined distance such as 10 km.

In the example embodiment, an average value of the frequency spectrum obtained from displacement of the detected lateral position data may be used as the “predetermined threshold”. As the “predetermined threshold”, for example, a value empirically obtained by experiment, or a threshold predetermined by simulation may be used, in addition to the above-described average value. For example, the sway determiner 10D may determine that “a sway warning is to be issued” when the degree of swaying calculated above exceeds the predetermined threshold (e.g., the average value of intensity in the spectrum described above) for a given period of time.

As described above, the control processor 10 performs a “normal sway determination process” of determining the swaying based on a change in the distance of the vehicle 100, i.e., the temporal change in the lateral position data, with respect to the division line provided on the road surface on which the vehicle 100 travels. In one embodiment, the normal sway determination process may serve as a “first determination process”. Note that, in addition to the above technique, the control processor 10 may, for example, determine the swaying of the vehicle when the division line is detectable by using a known sway determination technique exemplified in JP-A No. H09-39601.

### Emergency Sway Determination Process

Further, the control processor 10 performs an “emergency sway determination process” of determining the swaying of the vehicle 100 based on the vehicle behavior data held in the memory MD, when the above-described division line is not detected during traveling, i.e., in an emergency. In one embodiment, the emergency sway determination process may serve as a “second determination process”.

In one example, when the division line is not detected by the division line detector 10A, the sway determiner 10D according to the example embodiment may calculate alternative history data of the vehicle 100, with respect to a time when the division line becomes undetectable. Here, the “alternative history data” may be data related to a travel history to be used as an alternative when the lateral position data is not obtained. Non-limiting examples of the alternative history data may include a temporal change in the yaw rate or the steering angle of the steering wheel 9.

The sway determiner 10D may refer to the temporal change during swaying in the yaw rate or the steering angle held in the memory MD by the vehicle behavior data holder 10C, and determine that “a sway warning is to be issued” if the alternative history data of the vehicle position calculated in an emergency is expressed also when the division line is recognized.

For example, in an emergency in which the division line is not detected, the sway determiner 10D may determine a degree of coincidence or similarity (approximation) between a frequency spectrum obtained by FFT calculation on the temporal change in the yaw rate or the steering angle of the vehicle 100, and a frequency spectrum obtained by FFT calculation on the temporal change during swaying in the yaw rate or the steering angle held in the memory MD by the vehicle behavior data holder 10C.

As a method of calculating the degree of coincidence between the two spectra, it is possible to apply various known calculation expressions, such as a calculation expression exemplified in JP-A No. H09-184761, for example, or calculation of Euclidean distance as time series data.

Instead of the above-described known method of calculating the degree of coincidence, in an emergency in which the division line is not detected, the sway determiner 10D may use another known technique of analyzing correlation in a frequency space, to calculate coherence between the frequency spectrum obtained by the FFT calculation on the temporal change in the yaw rate or the steering angle of the vehicle 100, and the frequency spectrum obtained by the FFT calculation on the temporal change during swaying in the yaw rate or the steering angle held in the memory MD by the vehicle behavior data holder 10C. In this case, for example, when a value of the above-described coherence exceeds 0.8 as the “predetermined threshold”, the sway determiner 10D may determine that the alternative history data of the vehicle position calculated in an emergency is expressed also when the division line is recognized, i.e., is similar to the vehicle behavior data when the division line is detected.

### Notification Controller 10E

The notification controller 10E may be configured to, when it is determined that “a sway warning is to be issued” by the sway determiner 10D, issue the warning to the driver, for example, via the notification device PD including the speaker SP and the display DP described above. Note that the notification controller 10E may be coupled to an external terminal such as a smartphone carried by an occupant to issue the warning.

### Traveling State Determination Method

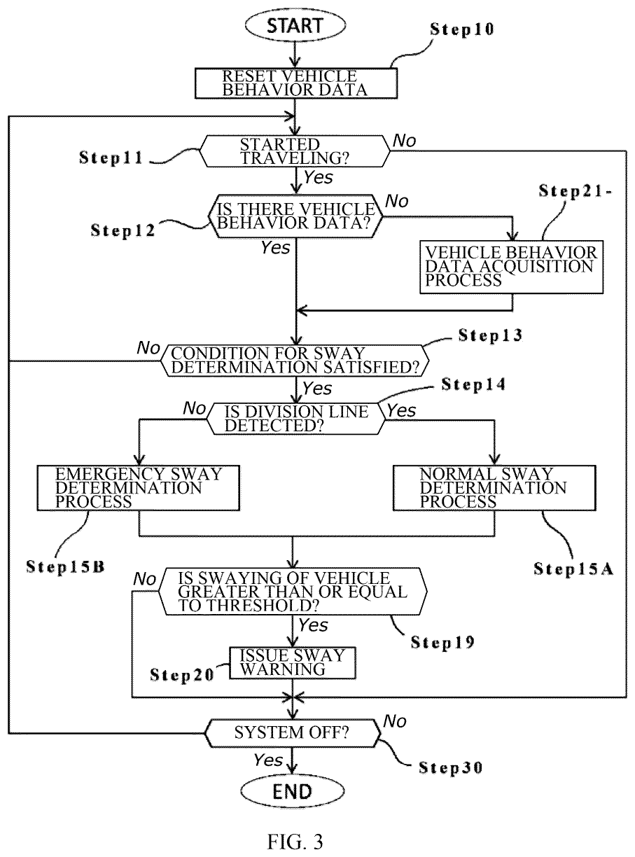

Referring now to FIG. 3, a traveling state determination method according to the example embodiment will be described. The traveling state determination method may be used as an algorithm of a program (a traveling state determination program) to be executable by the above-described control processor 10. The program including such an algorithm may be, for example, distributed to be downloadable via a known network, or distributed as a recording medium containing the program.

When a power supply system of the vehicle 100 is turned ON, the vehicle behavior data in the memory MD may first be reset in Step 10. This deletes the vehicle behavior data acquired in the previous traveling and allows the traveling state to be determined based on new vehicle behavior data.

Thereafter, it may be determined whether the vehicle 100 has started traveling in Step 11. If the traveling has not yet been started even after elapse of a predetermined period of time (“No” in Step 11), the process may proceed to Step 30, and it may be determined whether the power supply system has been turned OFF. If the power supply system has not yet been turned OFF in Step 30 (“No” in Step 30), the process may return to Step 11, and it may be determined again whether the vehicle 100 has started traveling.

If the vehicle 100 has started traveling in Step 11 (“Yes” in Step 11), it may be determined whether the vehicle behavior data is held in the memory MD of the vehicle 100 in Step 12. In this example, the vehicle behavior data may not be held in the memory MD (“No” in Step 12) because the traveling has just started, and a vehicle behavior data acquisition process may be started in Steps 21 to 26 to be described in detail later. Thus, in parallel with the sway determination of the vehicle 100 performed by the normal sway determination process, the vehicle behavior data when the vehicle 100 is swaying may be sequentially acquired and stored in the memory MD.

Note that a case where the process proceeds to Steps 15B and 19 without the vehicle behavior data being sufficiently obtained may be assumed at the beginning of the traveling. In such a case, tentative vehicle behavior data during swaying may be calculated by experiment or simulation and stored in the memory MD in advance. The tentative vehicle behavior data may be used in an emergency in Steps 15B and 19.

In Step 13, it may be determined whether a start condition for the sway determination is satisfied in the vehicle 100 that is traveling. As an example of the start condition for the sway determination, it may be determined that the start condition is satisfied, for example, when start factors exemplified below all become OFF. Non-limiting examples of the start factors may include whether a turn signal lamp of the vehicle 100 is lit and whether the vehicle speed of the vehicle 100 is 0 km/h.

If the start condition for the sway determination is satisfied in Step 13 (“Yes” in Step 13), it may be determined whether the division line on the road surface on which the vehicle 100 travels is detectable in Step 14. In one example, the traveling state determination apparatus (the division line detector 10A of the control processor 10) may detect the division line provided on the road surface on which the vehicle 100 travels via the above-described surrounding environment sensor SR₁. In this case, the traveling state determination apparatus (the division line detector 10A of the control processor 10) may, for example, determine whether the division line is provided on one side or both sides on the road surface on which the vehicle 100 travels, i.e., at least one side of both sides of the vehicle 100.

If the above-described division line is detected in Step 14 (“Yes” in Step 14), the process may proceed to Step 15A and thereafter to Step 19, and the traveling state determination apparatus (the lateral position data calculator 10B and the sway determiner 10D of the control processor 10) may determine the swaying based on the change in the distance of the vehicle 100 with respect to the division line, i.e., the temporal change in the lateral position data, as described above. The normal sway determination process may thus be performed. In Step 19 using the “threshold” in this case, for example, it may be determined whether the degree of swaying exceeds the average value of the frequency spectrum obtained from the displacement of the above-described lateral position data for the given period of time.

In contrast, if the above-described division line is not detected in Step 14 (“No” in Step 14), the process may proceed to Step 15B and thereafter to Step 19, and the traveling state determination apparatus (the sway determiner 10D of the control processor 10) may determine whether the alternative history data of the vehicle 100 (e.g., the temporal change in the yaw rate or the steering angle of the steering wheel 9) coincides with or is similar to the temporal change during swaying in the yaw rate or the steering angle held in the memory MD, with respect to the time when the division line becomes undetectable, as described above. The emergency sway determination process may thus be performed. For example, the degree of coincidence or similarity may be determined between the frequency spectra obtained by FFT-converting the above-described temporal changes, as described above. In Step 19 using the “threshold” in this case, for example, it may be determined whether the value of the coherence between the two spectra compared exceeds 0.8, or whether the degree of coincidence is high.

If the swaying of the vehicle 100 becomes greater than or equal to the threshold and it is determined that a sway warning is to be issued in Step 19 (“Yes” in Step 19), the traveling state determination apparatus (the notification controller 10E of the control processor 10) may issue the sway warning to the driver, for example, via the above-described notification device PD, a smartphone, etc. in Step 20.

### Method of Vehicle Behavior Data Acquisition Process

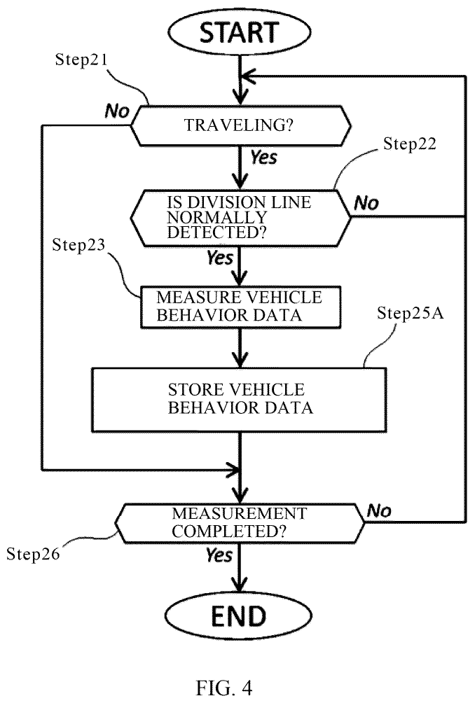

Referring now to FIG. 4, a method of the vehicle behavior data acquisition process that may be performed in the traveling state determination method will be described. The method of the vehicle behavior data acquisition process may be used as an algorithm of the program (the traveling state determination program) to be executable by the above-described control processor 10, as with the traveling state determination method.

As described above, when the vehicle behavior data is not held in the memory MD, the traveling state determination apparatus (the vehicle behavior data holder 10C of the control processor 10) may perform the process of acquiring the vehicle behavior data in the vehicle 100 that is traveling.

For example, it may be determined whether the vehicle 100 is traveling in Step 21. If, for example, the vehicle 100 continues to be stopped for a predetermined period of time and is not traveling (“No” in Step 21), the process may proceed to Step 26, and it may be determined whether measurement has been completed. If the vehicle behavior data has not yet been acquired and the measurement has not been completed in Step 26 (“No” in Step 26), the process may return to Step 21 and the vehicle behavior data acquisition process may be performed.

In contrast, if it is determined in Step 21 that the vehicle 100 is traveling (“Yes” in Step 21), it may be determined whether the division line is normally detected in Step 22. The traveling state determination apparatus (the division line detector 10A of the control processor 10) may determine, for example, whether the division line is provided on one or both sides of the road surface on which the vehicle 100 travels.

Thereafter, in Step 23, the above-described vehicle behavior data (e.g., the yaw rate or the steering angle data) may be measured in the vehicle 100 that is traveling, and in Step 25A, the measured vehicle behavior data may be stored in the memory MD in association with a result of the sway determination. For example, the vehicle behavior data may be held in the memory MD as data during non-swaying in a section in which the sway warning is not issued in Step 20, whereas the vehicle behavior data may be held in the memory MD as data during swaying in a section in which the sway warning is issued in Step 20.

Thereafter, in Step 26, it may be determined whether the vehicle behavior data acquisition process has been completed. For example, when a predetermined amount and predetermined type of vehicle behavior data is stored in the memory MD, this measurement may be completed.

In this manner, when the vehicle behavior data is not held in the memory MD, the vehicle behavior data may be sequentially stored in the memory MD in the vehicle 100 that is traveling. This allows the control processor 10 to appropriately read, via the memory MD, the vehicle behavior data when the sway warning is issued by the vehicle 100.

As described above, the traveling state determination apparatus and the vehicle according to the first example embodiment help to stably determine the swaying of the vehicle even when the division line on the road surface on which the vehicle travels is not recognizable.

### Second Example Embodiment

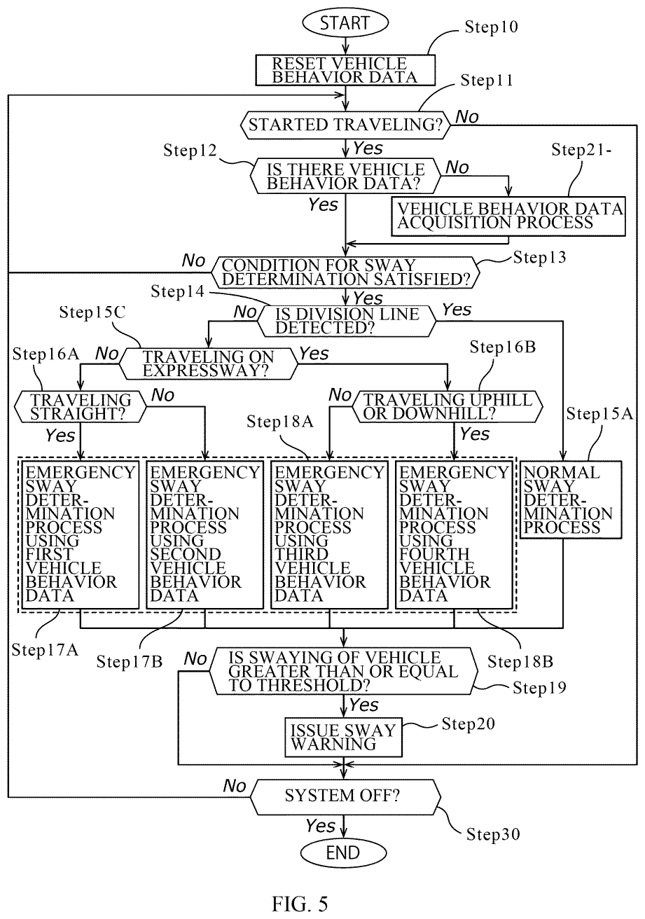

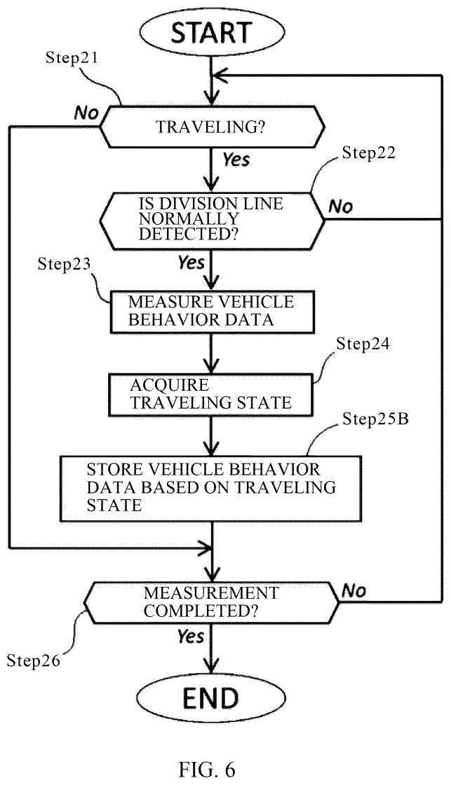

Referring now to FIGS. 5 and 6, a traveling state determination apparatus and a vehicle according to a second example embodiment will be described. The example embodiment may differ from the first example embodiment mainly in that the vehicle behavior data holder 10C stores the vehicle behavior data additionally including a property of the road surface (e.g., either a curve or a straight road, or either an ordinary road or an expressway). Accordingly, in the following, configurations common to those in the first example embodiment are denoted with the same reference numerals and description thereof is omitted as appropriate.

### Traveling State Determination Method

After going through Steps 10 to 13 as in the first example embodiment, it may be determined whether the division line is detected on the road surface on which the vehicle 100 travels in Step 14. If the division line is detected in Step 14 (“Yes” in Step 14), the process may proceed to Step 15A and thereafter to Step 19 as in the above example. The traveling state determination apparatus (the lateral position data calculator 10B and the sway determiner 10D of the control processor 10) may, as the normal sway determination process, determine the swaying based on the change in the distance of the vehicle 100 with respect to the division line, i.e., the temporal change in the lateral position data.

If the above-described division line is not detected in Step 14 (“No” in Step 14), the process may proceed to Step 15C, and the traveling state determination apparatus (the sway determiner 10D of the control processor 10) may determine whether the vehicle 100 is traveling on an expressway. In one example, the traveling state determination apparatus (the sway determiner 10D of the control processor 10) may acquire map data from a navigation device mounted on the vehicle or an external server outside the vehicle, for example, and determine whether the vehicle 100 is traveling on the expressway based on the map data. In addition to the above technique, the traveling state determination apparatus (the sway determiner 10D of the control processor 10) may determine whether the vehicle 100 is traveling on the expressway by various known methods.

If it is determined in Step 15C that the vehicle 100 is not traveling on the expressway (“No” in Step 15C), in Step 16A, the traveling state determination apparatus (the sway determiner 10D of the control processor 10) may determine whether the vehicle 100 is traveling straight. In one example, the traveling state determination apparatus (the sway determiner 10D of the control processor 10) may determine whether the vehicle 100 is traveling straight based on, for example, the data obtained from the vehicle sensor SR (e.g., the yaw rate sensor or the lateral acceleration sensor) or the map data described above. In addition to the above technique, the traveling state determination apparatus (the sway determiner 10D of the control processor 10) may determine whether the vehicle 100 is traveling straight by various known methods.

If it is determined in Step 16A that the vehicle 100 is traveling straight (“Yes” in Step 16A), in Step 17A, the traveling state determination apparatus (the sway determiner 10D of the control processor 10) may determine whether the alternative history data of the vehicle 100 (e.g., the temporal change in the yaw rate or the steering angle of the steering wheel 9) coincides with or is similar to the temporal change during swaying in the yaw rate or the steering angle held in the memory MD, by using first vehicle behavior data when the vehicle 100 is traveling straight.

If it is determined in Step 16A that the vehicle 100 is traveling on a curve without traveling straight (“No” in Step 16A), in Step 17B, the traveling state determination apparatus (the sway determiner 10D of the control processor 10) may determine whether the alternative history data of the vehicle 100 (e.g., the temporal change in the yaw rate or the steering angle of the steering wheel 9) coincides with or is similar to the temporal change during swaying in the yaw rate or the steering angle held in the memory MD, by using second vehicle behavior data when the vehicle 100 is traveling on the curve.

In contrast, if it is determined in Step 15C that the vehicle 100 is traveling on the expressway (“Yes” in Step 15C), in Step 16B, the traveling state determination apparatus (the sway determiner 10D of the control processor 10) may determine whether the vehicle 100 is traveling uphill or downhill. In one example, the traveling state determination apparatus (the sway determiner 10D of the control processor 10) may determine whether the vehicle 100 is traveling uphill or downhill based on, for example, the data obtained from the vehicle sensor SR (e.g., the vehicle speed sensor or the acceleration sensor). In addition to the above technique, the traveling state determination apparatus (the sway determiner 10D of the control processor 10) may determine whether the vehicle 100 is traveling uphill or downhill by various known methods.

If it is determined in Step 16B that the vehicle 100 is traveling on a flat road (“No” in Step 16B), in Step 18A, the traveling state determination apparatus (the sway determiner 10D of the control processor 10) may determine whether the alternative history data of the vehicle 100 (e.g., the temporal change in the yaw rate or the steering angle of the steering wheel 9) coincides with or is similar to the temporal change during swaying in the yaw rate or the steering angle held in the memory MD, by using third vehicle behavior data when the vehicle 100 is traveling fast, i.e., at a higher speed than when the vehicle 100 is normally traveling.

If it is determined in Step 16B that the vehicle 100 is traveling uphill or downhill (“Yes” in Step 16B), in Step 18B, the traveling state determination apparatus (the sway determiner 10D of the control processor 10) may determine whether the alternative history data of the vehicle 100 (e.g., the temporal change in the yaw rate or the steering angle of the steering wheel 9) coincides with or is similar to the temporal change during swaying in the yaw rate or the steering angle held in the memory MD, by using use fourth vehicle behavior data when the vehicle 100 is traveling uphill or downhill.

### Method of Vehicle Behavior Data Acquisition Process

After going through Steps 21 to 23 as in the first example embodiment, in Step 24, the data related to the traveling state while the vehicle behavior data is being acquired may be acquired. The traveling state determination apparatus (the vehicle behavior data holder 10C of the control processor 10) may determine, as the traveling state, whether the vehicle 100 is traveling straight, traveling on a curve, traveling fast, or traveling uphill or downhill.

Thereafter, in Step 25B, the traveling state determination apparatus (the vehicle behavior data holder 10C of the control processor 10) may perform a process of adding the determined traveling state to the vehicle behavior data and storing the resulting vehicle behavior data in the memory MD. Thus, the traveling state of the vehicle 100 when the vehicle behavior data is acquired may be stored as well.

As described above, in some embodiments, at least the first vehicle behavior data when the vehicle 100 is traveling straight and the second vehicle behavior data when the vehicle 100 is traveling on the curve may be held in the memory MD. In some embodiments, the third vehicle behavior data when the vehicle 100 is traveling fast may be further held in the memory MD. In some embodiments, the fourth vehicle behavior data when the vehicle 100 is traveling uphill or downhill may be further held in the memory MD.

In the emergency sway determination process, the traveling state determination apparatus (the sway determiner 10D of the control processor 10) may select and acquire any of the first vehicle behavior data, the second vehicle behavior data, the third vehicle behavior data, and the fourth vehicle behavior data in accordance with the traveling state of the vehicle 100, and determine the swaying based on the acquired vehicle behavior data.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or Step but not the exclusion of any other non-stated element, integer, or Step.

The use of the terms first, second, etc. does not denote any order or importance, but rather the terms first, second, etc. are used to distinguish one element from another.

The terms “substantially”, “about”, and their variants having similar meanings thereto are defined as being largely but not necessarily wholly what is specified as understood by one of ordinary skill in the art.

The terms “disposed on”, “provided on”, and its variants having similar meanings thereto as used herein refer to elements disposed directly in contact with each other or indirectly by having intervening structures therebetween.

The traveling state determination apparatus and the vehicle according to at least one embodiment of the disclosure help to determine the swaying of the vehicle even when the division line on the road surface on which the vehicle travels is not recognizable.

The control processor 10 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control processor 10 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control processor 10 illustrated in FIG. 1.

1. A traveling state determination apparatus configured to be applied to a vehicle, the traveling state determination apparatus comprising:
a memory configured to hold vehicle behavior data acquired by a vehicle sensor configured to detect a behavior of the vehicle; and
a control processor configured to determine swaying of the vehicle during traveling, based on the vehicle behavior data held in the memory, wherein
the control processor is configured to perform
a first determination process of determining the swaying of the vehicle, based on a change in a distance of the vehicle with respect to a division line provided on a road surface on which the vehicle travels, and
a second determination process of determining the swaying of the vehicle, based on the vehicle behavior data, when the division line is not detected.

2. The traveling state determination apparatus according to claim 1, wherein
the memory is configured to at least hold, as the vehicle behavior data, first vehicle behavior data when the vehicle is traveling straight and second vehicle behavior data when the vehicle is traveling on a curve, and
the control processor is configured to, in the second determination process,
select the first vehicle behavior data or the second vehicle behavior data in accordance with a traveling state of the vehicle, and
determine the swaying of the vehicle, based on the first vehicle behavior data or the second vehicle behavior data selected.

3. The traveling state determination apparatus according to claim 2, wherein
the memory is configured to further hold, as the vehicle behavior data, third vehicle behavior data when the vehicle is traveling at a higher speed than when the vehicle is normally traveling, and
the control processor is configured to, in the second determination process,
acquire the third vehicle behavior data in accordance with the traveling state of the vehicle, and
determine the swaying of the vehicle, based on the third vehicle behavior data acquired.

4. The traveling state determination apparatus according to claim 2, wherein
the memory is configured to further hold, as the vehicle behavior data, fourth vehicle behavior data when the vehicle is traveling uphill or downhill, and
the control processor is configured to, in the second determination process,
acquire the fourth vehicle behavior data in accordance with the traveling state of the vehicle, and
determine the swaying of the vehicle, based on the fourth vehicle behavior data acquired.

5. The traveling state determination apparatus according to claim 3, wherein
the memory is configured to further hold, as the vehicle behavior data, fourth vehicle behavior data when the vehicle is traveling uphill or downhill, and
the control processor is configured to, in the second determination process,
acquire the fourth vehicle behavior data in accordance with the traveling state of the vehicle, and
determine the swaying of the vehicle, based on the fourth vehicle behavior data acquired.

6. A vehicle comprising:
the traveling state determination apparatus according to claim 1; and
the vehicle sensor.
